(19) United States
(12) Patent Application Publication
(10) Pub. No.: US 2026/0127785 A1
(43) Pub. Date: May 7, 2026

(54) APPLICATIONS FOR GAIN CURVES IN IMAGING AND VIDEO

(71) Applicant: APPLE INC., Cupertino, CA (US)

(72) Inventors: Nicolas P BONNIER, Mountain View, CA (US); Ching E HO, San Jose, CA (US); Luke S WALLIS, San Francisco, CA (US); Alexandros TOURAPIS, Los Gatos, CA (US); Jackson K ROLAND, San Francisco, CA (US); Davide CONCION, Campbell, CA (US); Mark A ZIMMER, Aptos, CA (US)

(21) Appl. No.: 19/352,135

(22) Filed: Oct. 7, 2025

Related U.S. Application Data
(60) Provisional application No. 63/717,260, filed on Nov. 6, 2024.

(51) Int. Cl. G06T 11/20; G06T 5/20; G06T 5/70; G06T 7/90; G06V 10/25

(52) U.S. Cl. CPC G06T 11/26; G06T 5/20; G06T 5/70; G06T 7/90; G06T 11/23; G06V 10/25; G06T 2207/10016; G06T 2207/10024; G06T 2207/20072

(57) ABSTRACT

Techniques are disclosed relating to exchange of images in networked computing applications. In particular, the disclosure relates to exchange of gain curves that are used to represent imaging and/or video in such applications. A gain curve may define a mathematical transformation that relates values from a source image domain to a destination image domain. The image and its associated gain curve(s) may be published to destination devices for consumption. When a destination device consumes the image, the destination device may apply a transform to source image content according to the gain curve(s) published with the image. For example, the destination device may apply a gain curve to an associated image directly, or it may derive another transform from the gain curve and additional information known to the destination device.

### CLAIM FOR PRIORITY

The present application benefits from priority of U.S. patent application Ser. No. 63/717,260, entitled “Applications for Gain Curves in Imaging and Video” and filed Nov. 6, 2024, the disclosure of which is incorporated herein in its entirety.

### BACKGROUND

The present disclosure relates to exchange of images in networked computing applications. In particular, the disclosure relates to exchange of gain curves that are used to represent imaging and/or video in such applications.

Image exchange is a well-known operation of modern networked computer systems. Typically, an image is a spatial array of picture elements that, when displayed together, convey image information. A video typically is a time ordered array of images that, when displayed together, convey moving picture information. Image and video information are represented in files that define how the image information is to be represented.

It oftentimes can occur that devices that generate image and/or video data and the devices that consume image and/or video data have different operational properties. As a result, the same image and/or video information may be displayed differently on different destination devices, and the displayed images and/or video may have different properties than the source image that was generated when the image and/or video first was generated. The present disclosure is directed to techniques for improving uniformity in images in these scenarios.

### BRIEF DESCRIPTION OF THE DRAWINGS

FIG. 1 illustrates a system according to an embodiment of the present disclosure.

FIG. 2 is a flow diagram illustrating use of a gain curve according to an embodiment of the present disclosure.

FIG. 3 is a block diagram of a capture device according to an embodiment of the present disclosure.

FIG. 4 illustrates a fitted gain curve derived from an exemplary gain map according to an embodiment of the present disclosure.

FIG. 5 illustrates derivation of a destination image according to an embodiment of the present disclosure.

FIG. 6 illustrates exemplary headroom adaptation according to an embodiment of the present disclosure.

FIG. 7 illustrates derivation of a destination image according to an embodiment of the present disclosure.

FIG. 8 illustrates generation of a gain curve according to an embodiment of the present disclosure.

FIG. 9 illustrates derivation of a destination image according to an embodiment of the present disclosure.

FIGS. 10 and 11 illustrate exemplary relationships between images and gain curves according to embodiments of the present disclosure.

FIG. 12 illustrate exemplary relationships between images, regions of interest, and gain curves according to an embodiment of the present disclosure.

### DETAILED DESCRIPTION

The present disclosure relates to exchange of images in networked computing applications. In particular, the disclosure relates to exchange of gain curves that are used to represent imaging and/or video (collectively “images”) in such applications. A gain curve may define a mathematical transformation that relates values from a source image domain to a destination image domain. The image and its associated gain curve(s) may be published to destination devices for consumption. When a destination device consumes the image, the destination device may apply a transform to source image content according to the gain curve(s) published with the image. For example, the destination device may apply a gain curve to an associated image directly, or it may derive another transform from the gain curve and additional information known to the destination device.

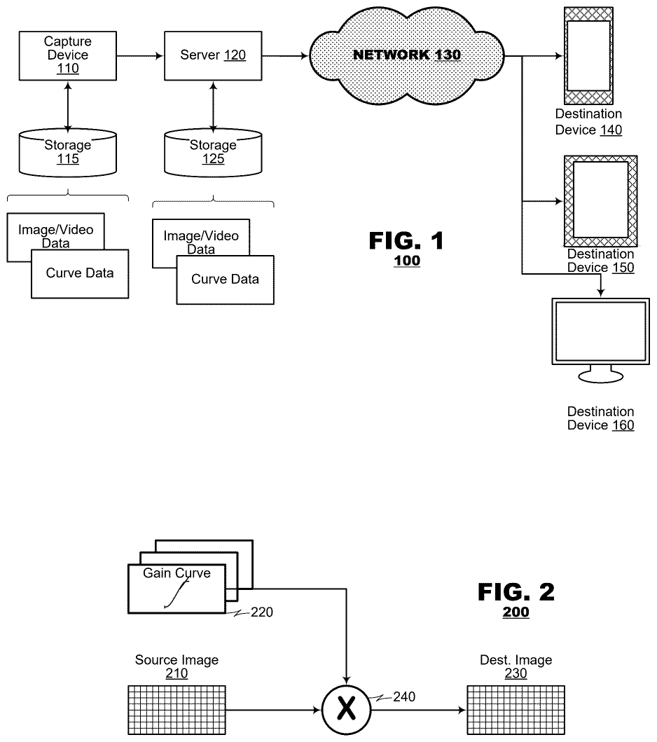

FIG. 1 illustrates a system 100 according to an embodiment of the present disclosure. There, the system 100 illustrates a capture device 110, a server 120, and a plurality of destination devices 140-160 provided in communication via a network 130. Gain curves may be generated by a capture device 110 (for example, a camera) that generates the source image/video data. Alternatively, the gain curves may be generated by a server 120 that receives the source image/video data from another source (such as the capture device 110). In either embodiment, the respective device 110, 120 may be made available to destination device(s) 140-160 via a communication network 130. Typically, although not required, the source image/video data and gain curves would be stored in local storage 115, 125 of the devices 110, 120 so that the source image/video data and gain curves may remain persistent for asynchronous delivery to the destination device(s) 140-160.

The capture device 110 represents a device that generates images of a local environment and provides them to another device. Typically, the capture device 110 is provided as a camera. The capture device 110 may be integrated with any number of consumer electronics devices (not shown), such as a personal computer, laptop or notebook computer, tablet computer, smartphone, gaming system, videoconferencing equipment and the like. For the purposes of the present discussion, the configuration of the consumer electronic device into which the capture device 110 is integrated is immaterial unless otherwise discussed below.

Embodiments of the present disclosure provide for image processing pipelines that generate images and associated gain maps, and process gain curves as the corresponding images are processed. The gain curves may represent a transformation of pixel values from a source domain to a destination domain.

FIG. 2 is a flow diagram illustrating use of a gain curve 220 to support a transformation (box 240) of an array 210 of image (or video) data in a source domain to an array 230 of image/video data in a destination domain. A gain curve 220 may be generated from a gain map provided in association with a source image 210. In practice, gain curves 220 can be provided that are specific to individual color components of image/video data 220. For example, for YCbCr data, a first set of transforms 220 may be provided for luma Y, and other set(s) of transforms 220 can be provided for chroma Cb and Cr. In an RGB color space, individual transforms 230 may be defined for R, for G, and for B color components.

There are several variants. For example, the image data of a single frame 210 may include one gain curve 220 that applies to all data in the frame. Alternatively, a single frame of image data 210 may include several gain curves 220, each of which may be applied to all data in the frame 210. Providing a plurality of gain curves supports selection at playback time, of one of the curves based on parameters that are present at playback, for example, a first curve may be selected for playback in bright environment, while a second curve may be selected for playback on a display of a certain size.

In a further embodiment, the image/video data of a single frame 210 may include pixel data represented as separate color components (e.g., RGB and the like). A gain curve 220 may be provided for each color component of the pixel data. If desired, for YCbCr data, it is permissible to provide one gain curve 220 for a Y component, and a separate gain curve 220 that applies to both the Cb and Cr components. Alternatively, separate gain curves 220 may be provided for Cb and Cr components of a source image 210.

If desired, the gain curves 220 may be defined for a color space that differs from the color space in which the source domain content (source image 210) is provided, which may involve a transform of source image/video data 210 from its provided color space to the space of the gain curve 220 (or to a destination domain, discussed below). Component data may but need not be linearized.

The transform can be specific to a spatial area of the image/video data 210, based on pixel locations (e.g., center versus periphery), or by other characteristics (e.g., semantic masks such as sky, faces, other detected objects, or an estimation of local contrast).

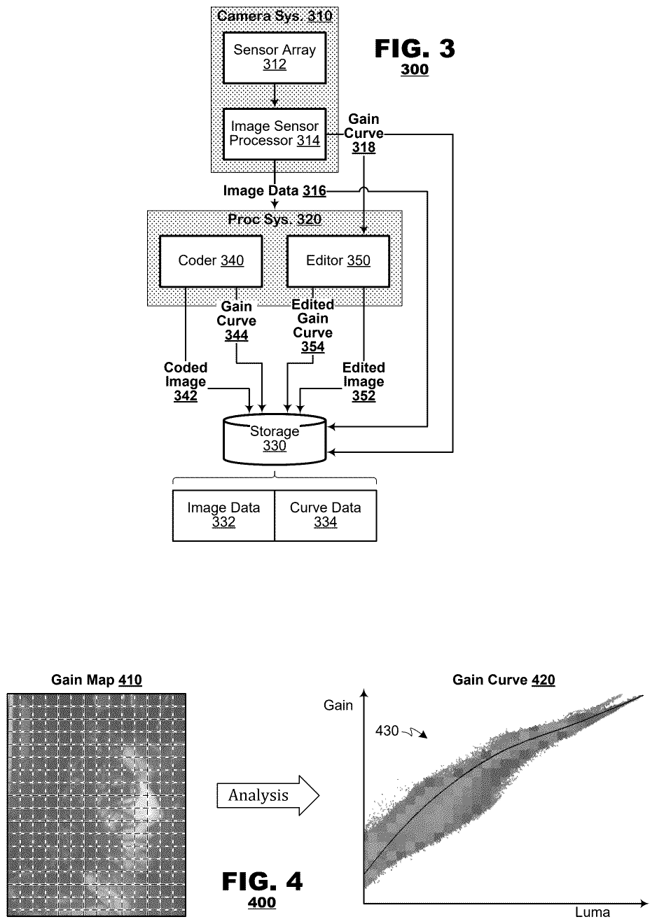

FIG. 3 is a block diagram of a capture device 300 according to an embodiment of the present disclosure. The capture device 300 may include a camera system 310, a processing system 320, and storage 330. The camera system 310 may include an image sensor array 312 and an image sensor processor 314. The image sensor array 312 may include circuitry for capturing incident light and generating an image signal therefrom. As such, the image sensor array 312 may include an array of pixel circuits (not shown), each of which generates a pixel value at a corresponding spatial location of an output image. The image sensor arrays 312 may include various pixel driver circuitry, readout circuitry, and analog-to-digital conversion circuitry (also not shown) that control pixel addressing and pixel exposure times during imaging. Pixel values output from the sensor array 312, typically, are digital values.

The image sensor processor 314 may perform processing operations upon the pixel value output from the image sensor array 312. For example, when the pixel circuits are used with optical filters (not shown) that cause the value output from each pixel circuit to represent a single color component of a multi-color image, an image sensor processor 314 may generate full color pixel values at each pixel location. The image sensor processor 314 may output image data from the camera system 310 that has been organized into images 316.

In an embodiment, the image sensor processor 314 may generate a gain curve data based on an analysis of image data as it generates the image data 316, which may be stored in storage 330 with the stored image 316. The gain curve can be generated from a gain map representing the frame data.

The processing system 320 may represent a suite of image processes that may be applied to image data 316 output from the camera system 310. For example, the processing system 340 may include an image coder that applies spatial- or motion-based compression to images 316 output from the camera system 310. Spatial coders exploit redundancy among pixel values in an input image 316 to generate a coded frame 342 that is a compressed representation of the input frame. Motion-based coders may exploit spatial and/or temporal redundancy in image data 316 to generate a coded video 342 that is a compressed representation of the input frames 316. Typically, the spatial- and motion-based coders 340 represent the compressed image data 342 according to inter-operability specifications so that decoder devices (not shown) that receive the compressed image data 342 may invert the compression operations applied by the coder 340 and generate recovered images therefrom.

In an embodiment, the coder 340 may apply image (or video) compression techniques to received image data 316 and, as part of those operations, generate a gain map in analysis. The coder 320 may generate a gain curve 344 from statistical analyses of the gain map. The gain curve 344 may be stored in storage 330 in association with coded frame data 342 generated by the coder 340.

Alternatively or in addition, the processing system 320 may include an image editor 350 that alters image data 316 from the camera system 310. The editor 350 may change pixel content of an input image 316 by, for example, replacing pixel values with other content, detecting and modifying content objects within images 316, altering frame properties, such as brightness, contrast, shadows, and tint, and cropping images. The editor 350 may output an edited image 352.

The editor 350 may generate a gain map and, from that gain map, a gain curve based on statistical analyses of the gain map. An editor 350 may provide tools that allow the device operator to edit the gain curve before it is stored, which provides for author control over the gain curves. By allowing authors to edit the gain curve, these embodiments permit author control of the destination image(s) that are derived using the gain curve. The gain curve 354 may be stored in storage 330 in association with edited frame data 352 generated by the editor 350.

The system 300 also may include storage 330 to store images output by the camera system 310 and/or the processing system 320. Stored images in storage 330 may be retrieved from storage and operated upon by the processing system 320 one or more times. Thus, it is permissible for the camera system 310 to generate an image that is placed in storage, to have the processing system retrieve the stored image, edit it by the editor 350 and place the edited image back in storage 330, then to have to coder 340 retrieve the edited image from storage, compress it, and place the compressed image in storage. As discussed, stored images may be stored with associated gain curve data, which may be retrieved from storage by the processing system 320 as images are stored, and which gain curves may be revised as the processing system 320 processes images and stored the processed images back in storage 330.

The processes of an editor 350 discussed above need not be performed in the same device in which image/video data is captured. For example, editor processes may be performed by a server system 120 (FIG. 1 above) upon image data generated by a capture device 110.

The gain curve can be generated from several sources. In one embodiment, the gain curve 220 (FIG. 1) may be generated from a gain map of a source image. For example, a gain map may be constructed from an image with spatial areas of the map representing gain of co-located regions of the source image.

An exemplary gain map 410 and a fitted gain curve 420 are shown in FIG. 4 for illustration. In this example, shading within the region 430 shown in the gain vs. luma graph illustrates the counts of pixels from a source gain map with the respective gain vs. luma ratio.

The principles of the present disclosure find application with gain curves generated from sources other than gain maps:

a. The gain curve can be generated from an analysis of image statistics.

b. A gain curve can be generated from metadata associated with an image or video sequence.

c. A gain curve can be generated from a static or a dynamic tone mapping algorithm.

d. A gain curve also can be generated to reproduce the aesthetic of another video sequence or still photography such as by employing a gain curve from the other sequence or still image.

e. A gain curve may be computed from a spatially-downsampled version of a source image (either in its source domain representation or a conversion of the source image to an alternate representation such as a gain map), and an analysis of the spatially-downsampled source image. Such an implementation is expected to conserve processing resources as compared to gain curve computations from the source image in its native resolution.

f. A gain curve may be generated from other curves, including fixed curves, such as an Opto-Optical Transfer Function (OOTF).

The gain curve 220 (FIG. 2) may be represented in a variety of ways:

a. A single gain curve may be represented as a piecewise linear function in which transitions between segments are represented by coordinates (e.g., x, y positions of transition points, or paired segment lengths and segment slopes).

b. A single gain curve may be represented as a piecewise cubic spline in which transitions between segments, again, are represented by coordinates (e.g., x, y positions of transition points or segment lengths, and segment slopes). In one embodiment, the spline may take the form:

| Luma | Gain | Slope |
|---|---|---|
| 0 | G₁ | M₁ |
| . | . | . |
| . | . | . |
| . | . | . |
| 1 | G_{N+1} | M_{N+1} |

c. A single gain curve may be represented with a look up table. The look up table need not be provided in storage 430 directly. In embodiments where contents of the look up table are defined beforehand, gain curves may be defined in a library of gain curve tables, which may be identified by a table index stored in association with stored image and/or video frame(s).

d. A gain curve may be stored in a file format (e.g., ISOBMFF) in Video Usability Information (VUI), a supplemental enhancement information (SEI), or an open bitstream unit (OBU) according to a syntax of a coding protocol through which the image/video information is represented. Such data may be static, or it may be dynamic, and it may vary on a per frame or per scene basis.

e. A single gain curve may be represented as parametric curve parameters (e.g., polynomials, gamma, exponentials, etc.).

f. A gain curve for multiple color components of a given color space may be defined as a three-dimensional curve. In such an embodiment, each color component's gain value may have contribution from all three color components of image content. See, for example, § 1.2.1 of Annex 1 below.

g. Alternatively, the gain curves for the various color components of a color space may be represented independently as a plurality of independent single gain curves.

Gain curve data may be represented according to predictive techniques. A gain curve 220 for one image or span of frames (video) may be predicted from gain curves 220 defined for an earlier-represented image or video.

a. For example, prediction data for a new gain curve 220 may identify a previously-defined gain curve 220 as a reference for prediction, and the prediction data may contain additional parameters that refine the predicted gain curve. In this manner, signaling of a new gain curve may be provided in a manner that conserves bandwidth.

b. Gain curve prediction may apply multi-hypothesis prediction, which may predict a gain curve by averaging or weighted averaging a plurality of previously-defined gain curves identified in prediction data, and refining a resultant gain curve with any additional parameters provided in the prediction data.

Data of the gain curve 220 may be subject to compression and decompression operations when written to and read from storage 115, 125 (FIG. 1).

Returning to FIG. 2, a gain curve 220 (FIG. 2) typically will express a transform that may be used to transform 240 image data from a source domain 310 to a destination domain 230. The destination domain may be defined in a manner that allows a device 140, 150, 160 (FIG. 1) that will consume the source domain image(s) 210 to determine whether its own use of the source domain image 210 deviates from the destination domain represented by the gain curve 220.

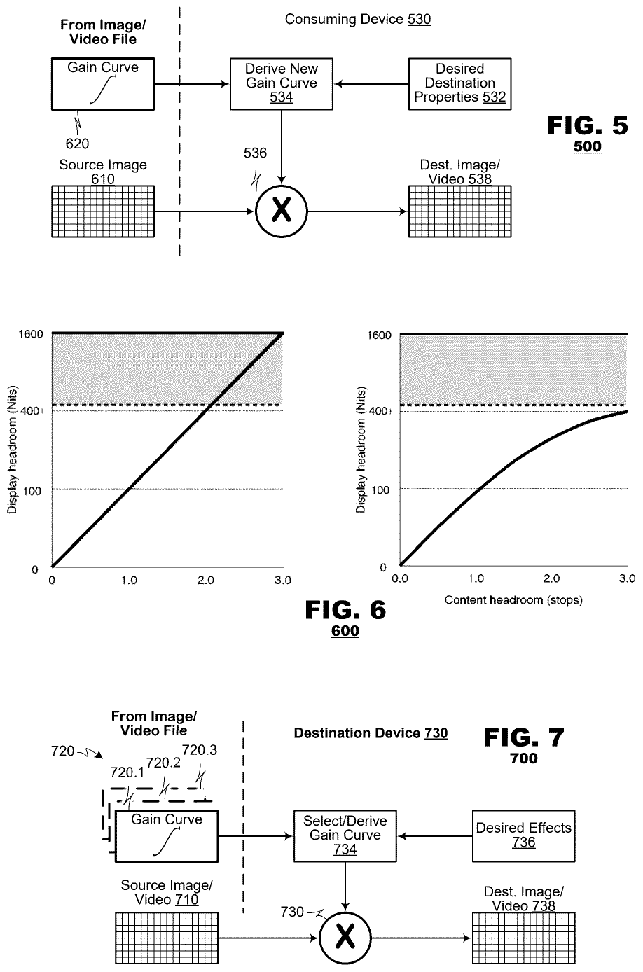

An exemplary use case is illustrated in FIG. 5. For example, source domain image data 610 may be represented in a high dynamic range (“HDR”) format and the gain curve 620 may provide for a transformation of the source domain image data 610 to a standard dynamic range (“SDR”) format. A device 530 (FIG. 1) that consumes the image data 610 may employ a third format that differs from the SDR format. Such a device 610 may employ the gain curve 620 provided with the image data 610, using information 532 regarding its desired format, to derive another gain curve 534 that may be used to transform 536 the source domain image data 610 to its desired format. Image data 536 generated from the transform 536 may be used at the consuming device 530 as a destination image 538.

In one embodiment, gain curves 220 (FIG. 2) provide a technique to adapt image data to peak display values of a destination display at destination devices 140, 150, 160 (FIG. 1). Displays can vary in the brightness that they can achieve when displaying white image content. A destination display may adapt the gain curve(s) 220 provided for an image or (as discussed below) video to fit a profile of the local device's capabilities as represented in FIG. 6.

Gain curves also may be employed to impart aesthetic effects to video as represented in FIG. 7. An image 710 may have multiple gain curves 720 defined for it that, when applied 730 to source video 710, transform the video in different ways. For example, a first gain curve 720.1 may be defined to impart a “natural” look to associated image content 710, a second gain curve 720.2 may be defined to impart a desaturated look to the image content 710, and a third gain curve 720.3 may be defined to impart an oversaturated look to the image content 710. When the image 710 is consumed, a destination device 730 may select one of the gain curves (or derive one from a combination of the gain curves) based on its determination of desired effects 736 to determine a destination image 738.

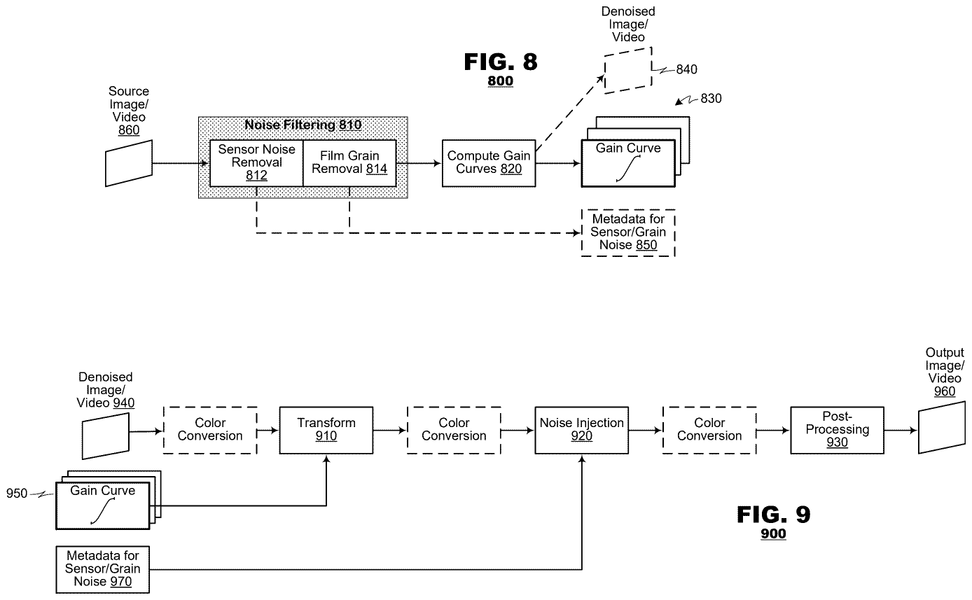

FIG. 8 illustrates a system 800 for generating gain curves according to an embodiment of the present disclosure. The system 800 may include a noise filtering system 810 and a gain curve calculation unit 820. The noise filtering system 810 may subject a source image 860 to denoise processing prior to generation of gain curve(s) 820. Filtering 810 may be performed, for example, using motion compensated temporal filtering. Gain curves 830 generated from the gain curve computation process 820 are expected to be more accurate for transform purposes than would gain curves generated from source image/video 860 with such noise remaining.

In an embodiment, the source image/video 860 (without denoising applied) may be published for consumption with the gain curves 830 so generated. Alternatively, a denoised variant 840 of the source image/video may be published with metadata 850 describing characteristics of the sensor/grain noise so removed. For example, noise maps may be generated representing differences between the source image/video and filtered image/video generated by the noise filtering process 810. In an embodiment, a plurality of such noise maps may be generated for different color domains and different spatial resolutions.

A source image/video often includes noise components from a variety of sources, including sensor noise and film grain noise. The noise filtering process 810 may remove such artifacts. If desired, noise removal algorithms 812, 814 tailored to remove such artifacts may be applied in the noise filtering process 810. In an embodiment, noise filtering 810 operations may be defined to distinguish and retain noise from sources that are intended to be present in an image/video; such as noise effects introduced by an author of the image/video to achieve aesthetic goals.

FIG. 9 illustrates a noise processing system 900 according to an embodiment of the present disclosure. The noise processing system 900 may be employed in a destination device 140, 150, 160 (FIG. 1). As illustrated, a denoised image/video 940 may be processed by a transform 910 using transform parameters defined in a selected gain curve 950. Noise injection 920 may be performed; noise injection may be an additive process that applies a noise profile as defined in metadata to an image/video input to the noise injection processor. Prior to output, output image/video 960 also may be subject to post-processing, such as sharpening filtering or contrast enhancement to prepare the output image/video 960 for output from the process.

The foregoing illustration describes the noise injection process 920 as being performed after application of a transform 910. If desired, noise injection 920 may be performed before the transform 910.

As discussed, transforms 910 and noise injection processes 920 may be performed in color spaces for which the gain curves 950 and metadata 970 are defined. The processing operations described in the foregoing illustration may include color conversion operations, as appropriate, to convert image/video data at one stage of a processing pipeline to a color space on which a subsequent processing stage will operate. Further, it may occur that the processing stages 910 and 920 are performed in different color spaces from the color space of the output image/video; a further color conversion operation may be performed, as needed, to adapt the processed image/video to a color space of the output image/video 950. Thus, during operation of the foregoing processing pipeline, a selection/synthesis of a gain curve and/or noise metadata may be determined by operating conditions of the destination device.

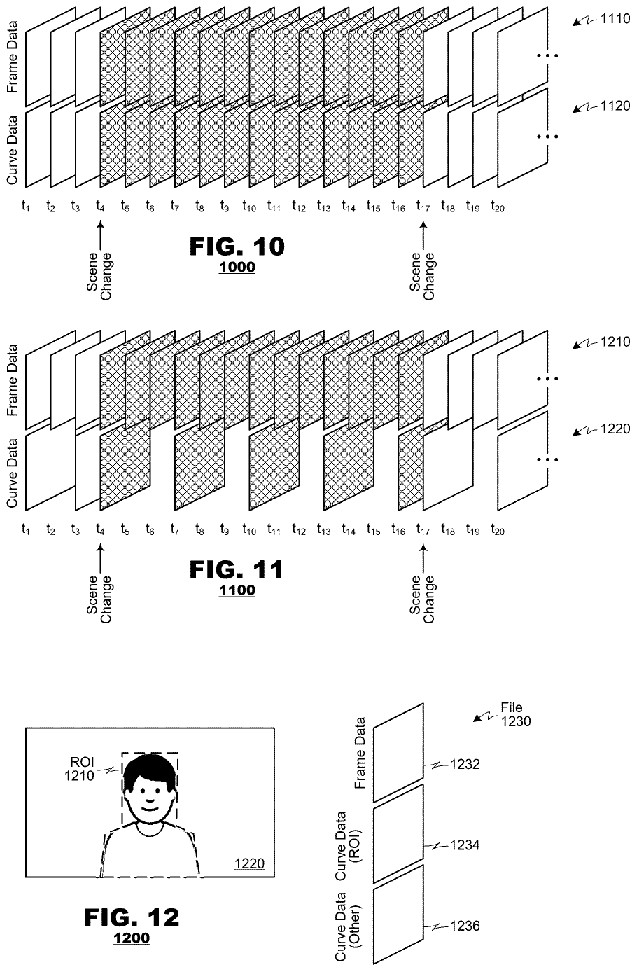

As discussed, the principles of the present disclosure find application to video. Shown in FIG. 10, a video sequence 1000 may be represented by a sequence 1010 of frames f₁-f₂₀ that represent motion video. In an embodiment, video frames may be stored with corresponding gain curves 1020 defined for each frame. The example of FIG. 10 shows a set of 20 frames f₁-f₂₀ in an exemplary video sequence each with a gain curve. It is not required that gain curves be provided for every frame in a video sequence; in other embodiments, a reduced number of gain curves can be obtained by temporally subsampling the gain curves that are generated for each frame in the video sequence, shown in the example of FIG. 11 which yields a smaller number of gain curves for storage.

When gain curves are provided at a reduced temporal rate than the frame(s) with which they are associated (FIG. 11), relationships between the gain curves 1220 and their corresponding frame(s) 1210 may be signaled either explicitly or implicitly. For example, metadata may be provided with the gain curves 1220 that identify a rate at which gain curves 1220 are provided with respect to predetermine locations (such as scene change locations, Intra Random Access Pictures (“IRAP”) locations, and the like) in frame data 1210. Spans of frames 1210 that share gain curves 1220 may be identified.

And, of course, a gain curve may be generated from an analysis of a plurality of frames (say, the frames at t₄ to t₁₆), rather than generating frame-specific gain curves in a first step and subsampling in a separate second step. Such an embodiment may conserve processing resources as compared to the subsampling case.

Further, it is permissible to define a single curve on a per scene basis. In the example of FIGS. 10 and 11, there would be a single curve (not shown) defined for the span of frames from t₄ to t₁₆.

Gain curves may be represented in metadata provided for an associated video. In such applications, the gain curve may be represented by data identifying:
a. A start frame of a span of video frames to which the gain curve applies,
b. An end frame of the span of video frames to which the gain curve applies, and
c. Properties of the curve (such as the piecewise linear, piecewise cubic spline segments, a look up table index, or parametric curve parameters discussed above).

In another embodiment, gain curves for a span of video may be defined by:
a. Defining a gain curve for a first frame in the span,
b. Defining a gain curve for a last frame in the span, and
c. Interpolating gain curves for frames at intermediate temporal locations between the first and last frames in the span, using the gain curves at the first and last frames as references.

The video may contain several frames and several gain curves. One or several curves may be associated to one or several frames in the video. Several curves may be combined to generate a new curve applied to a specific curve, to provide temporal and spatial stability.

Gain curves may be subject to smoothing operations to reduce artifacts that may arise due to discontinuities in gain curves across frames. Thus, when gain curves are created from source frames, the gain curves may be processed with reference to gain curves of neighboring temporal locations for smoothing purposes.

For example, for each frame N, curve profiles may be averaged across a sliding window of frames N−½w to N+½w (where w represents a window size) about the frame N. Frames within the window may be assigned equal weights. Alternatively, a weighted average may be performed where the weighting of curve profiles decreases with the distance of each frame from the frame N being processed.

It may occur that parameters for gain curve smoothing operations may be defined in metadata associated with the gain curves. The smoothing operations may be defined anew as desired, for example, at the occurrence of new scenes or new IRAP frames. Alternatively, infinite impulse response filtering or finite impulse response filtering may be employed.

Gain curve smoothing can be performed in a domain of the gain curve data (for example, log 2) or it may be performed on a domain of linearized pixel values.

In an embodiment, gain curve smoothing may be prevented from being performed across scene changes in video or across video spans in which overall gain varies by more than a threshold amount. When such scenarios are detected, a smoothing window may be adjusted to avoid regions across a scene change. Thus, using the example of FIGS. 10 & 11, a gain smoothing operation performed for a frame at time t₁₅ would not consider frames at times t₁₇ or greater due to the presence of a scene change.

In embodiments where gain curves are defined in a library of gain curve tables, the gain curves may be applied to normalize look and feel of a video when it is assembled from scenes provided by multiple video sources. For example, a video author, working at an editor 350 (FIG. 3), may compile a video from scenes obtained from different video sources (for example, different capture devices or different video service providers). Gain curves may be stored for each scene (or for frames of each scene) that are derived from the properties of those scene, representing a transform to a common destination domain. Thus, when the video is consumed, a destination device may apply the different source-specific gain curves to their respective scenes, which may normalize the perceptual quality of the overall video when it is displayed at the destination device.

The processes discussed above with respect to FIGS. 10 & 11 also apply to transforms of gain curves for consumption of video.

In an embodiment, represented in FIG. 12, video and/or image data may be parsed into regions of interest based on object detection, face detection, or other content discriminators, and gain curves may be defined independently for the different regions of a frame. The example of FIG. 12 illustrates frame content parsed into a foreground object 1210 (the ROI object), and the remainder of the frame as another object 1220. An exemplary file 1230 corresponding to the frame also is shown. Here, the file includes frame data 1232, a gain curve 1234 for the ROI object 1210, and a gain curve 1236 for the other region 1220.

When compositing several videos together, the associated gain curves may be averaged to generate a new gain curve, or one can be selected based on image quality metrics, or a new gain curve can be preferred.

One or several gain curves may be scaled, to reach the same alternate headroom and applied to each image, before compositing.

The foregoing techniques for curve smoothing in video applications also may apply to an embodiment where different gain curves are defined for different spatial regions of the frames. Similarly, the foregoing techniques for deriving new gain curves from the file's gain curves and properties of a destination consumption environment also may be applied to an embodiment where different gain curves are defined for different spatial regions of the frames. In such cases, it may be beneficial also to apply smoothing at boundaries between the objects 1210, 1220 to reduce presence of imaging artifacts that may arise from such processing.

### Application to ICC 1:2022

The principles of the present disclosure may be integrated with interoperability specifications related to image and/or video data. For example, it is expected that the International Color Consortium specification ICC.1:2022 (“ICC”) may be augmented to support the gain curves proposed herein as follows:

ICC may be supplemented to support optional gain curve tags defining an Adaptive Gain Curve with new formulas and functions describing how the curve can be applied to the image for the purpose of tone mapping. The tag shall indicate whether the included Adaptive Gain Curve is image-specific and thus uniquely applicable to one image, or whether it can be used for tone mapping multiple images. For example, a tag of “ADGC” may be defined to indicate the presence of a gain-based global tone mapping curve for an SDR or HDR image.

The adaptiveGainCurveType includes data and functions describing how the Adaptive Gain Curve can be applied to the image for the purpose of tone mapping for either HDR to SDR, SDR to HDR or HDR to HDR with a different headroom, and additional details on implementing the Tags and Type are given in informative Annexes 1 and 2 (below).

### A. ADGC Tag

Tag signature: ‘ADGC’ (41444743h)
Permitted tag type: adaptiveGainCurveType

This tag may indicate a gain-based global tone mapping curve for an SDR or HDR image.

It may be present when the data colour space in the profile header is RGB, and the profile class in the profile header is Input or Display. The tag shall not be present for other data colour spaces or profile classes indicated in the profile header. When the AGCT tag is image specific, the flags in the header may indicate that the profile may be embedded and would not be used independently of the color data shall be set (bit position 0=1 and bit position 1=1).

B. adaptiveGainCurveType

The adaptiveGainCurveType specifies a gain-based global tone mapping curve, adaptive to varying headroom, for conversion between HDR and SDR representations of the image. It consists of a header and curve data. The adaptive gain curve function, which describes the application of the adaptiveGainCurveType, is defined in Annex 2.

adaptiveGainCurveType Header

The byte assignment and encoding of the header may be given as in Table 1.

TABLE 1
adaptiveGainCurveType header encoding

| | Field | |
|---|---|---|
| Byte | length | |
| position | (bytes) | Content |
| 0 to 3 | 4 | ‘adgc’ (61646763h) type signature |
| 4 to 7 | 4 | Reserved, shall be set to 0 |
| 8 to 11 | 4 | Adaptive Gain Curve Function Type ID (set to 1 in |
| | | this version) |
| 12 to 27 | 16 | GUID (all zeros when Adaptive Gain Curve is not |
| | | image-specific) |
| 28 to 31 | 4 | H_{baseline} (baseline headroom in log base 2) |
| 32 to 35 | 4 | Hₐₗₜₑᵣₙₐₜₑ (alternate headroom in log base 2) |
| 28 to 31 | 4 | Red channel Gainₘᵢₙ (in log base 2) |
| 32 to 35 | 4 | Red channel Gainₘₐₓ (in log base 2) |
| 36 to 39 | 4 | Red channel weight coefficient (k_{Red}) |
| 40 to 43 | 4 | Green channel Gainₘᵢₙ (in log base 2) |
| 40 to 43 | 4 | Green channel Gainₘₐₓ (in log base 2) |
| 44 to 47 | 4 | Green channel weight coefficient (k_{Green}) |
| 48 to 51 | 4 | Blue channel Gainₘₐₓ (in log base 2) |
| 52 to 55 | 4 | Blue channel Gainₘᵢₙ (in log base 2) |
| 56 to 59 | 4 | Blue channel weight coefficient (k_{Blue}) |
| 60 to 63 | 4 | MAX(R, G, B) weight coefficient (k_{Max}) |
| 64 to 67 | 4 | MIN(R, G, B) weight coefficient (k_{Min}) |
| 68 to 71 | 4 | Color component weight coefficient (k_{Component}) |
| 72 to 75 | 4 | Pre-gain curve CICP (0 if no CICP specified) |
| | | uInt32Number |
| 76 to 79 | 4 | Post-gain curve CICP (0 if no CICP specified) |
| | | uInt32Number |
| 88 to 91 | 4 | Backward compatible A2B0 target headroom, 0.0: |
| | | not created |
| 92 to 95 | 4 | Backward compatible A2B1 target headroom, 0.0: |
| | | not created |
| 96 to 99 | 4 | Backward compatible A2B2 target headroom, 0.0: |
| | | not created |
| 100 to 107 | 8 | Red Adaptive Gain Curve data position |
| 108 to 115 | 8 | Green Adaptive Gain Curve data position |
| 116 to 123 | 8 | Blue Adaptive Gain Curve data position |
| 124 to 127 | 4 | Reserved for future use, shall be set to 0 |

NOTE.
Adaptive curve data offsets (byte positions 100-123) may be shared when the data is the same for the respective components.

### Adaptive Gain Curve Data

The byte assignment and encoding of the Adaptive Gain Curve data may be as given in Table 2.

| | Field | |
|---|---|---|
| Byte | length | |
| position | (bytes) | Content |
| 0 to 3 | 4 | Count of {x, y, slope} triplets in the table |
| 4 to 7 | 4 | x coordinate |
| 8 to 11 | 4 | y coordinate |
| 12 to 15 | 4 | slope value |
| . . . | . . . | . . . |
| 16 + (N − 1)*12 | 4 | x coordinate |
| 20 + (N − 1)*12 | 4 | y coordinate |
| 24 + (N − 1)*12 | 4 | slope value |

The foregoing description provides but one exemplary implementation of gain curves. Of course, different representations may be employed, consistent with the principles of the present disclosure, to represent the gain curves of the present disclosure.

### Annex 1 Adaptive Gain Curve Function (Normative)

### 1.1 General

The metadata in an ADGC tag shall be used to calculate output values according to the Adaptive Gain Curve Function.

### 1.2 Adaptive Gain Curve Function

The Adaptive Gain Curve Function comprises three steps:
1. an input evaluator
2. a gain evaluator
3. an output evaluator

### 1.2.1 Adaptive Gain Curve Input Evaluator

The mathematical formulation of the Input Evaluator is expressed as follows:

$$Input value [ component ] = {Red}^{*} {k}_{R e d} + {Green}^{*} {k}_{G r e e n} + {Blue}^{*} {k}_{B l u e} + {MAX ( Red , Green , Blue )}^{*} {k}_{Max} + MIN ( Red , Green , Blue ) {/}^{*} {k}_{Min} + {component}^{*} {k}_{Component}$$

Where component is one of {Red, Green, Blue}.

### 1.2.2 Adaptive Gain Curve Gain Evaluator

The mathematical formulation of the Gain Evaluator is expressed as a piecewise cubic curve:

$$F ( x ) = C 3 * {x}_{3} + C 2 * {x}_{2} + C 1 * x + C 0$$

where F(x) is normalized to be relative to the range of the gain values.

Each cubic is defined by a beginning triplet {x1, y1, slope1} and ending triplet {x2, y2, slope2}. The triplets are contained in Adaptive Gain Curve Data and encoded as described in Table 2.

Coefficients C3, C2, C1, C0 can be calculated using these triplets as follows:

$$C 3 = ( slope 1 + slope 2 - 2. * ( y 2 - y 1 ) / ( x 2 - x 1 ) ) / ( ( x 1 - x 2 ) * ( x 1 - x 2 ) )$$

$$C 2 = ( ( slope 2 - slope 1 ) / ( 2. * ( x 2 - x 1 ) ) ) - 1.5 * ( x 1 + x 2 ) * c 3$$

$$C 1 = slope 1 - 3. * x {1}_{2} * C 3 - 2. * x 1 * C 2$$

$$C 0 = y 1 - x {1}_{3} * C 3 - x {1}_{2} * C 2 - x 1 * C 1$$

### 1.2.3 Adaptive Gain Curve Output Evaluator

The mathematical formulation of the Output Evaluator comprises three steps:

1. Calculation of the target headroom weight coefficient:

$${W}_{target} = sign ( {H}_{alternate} - {H}_{baseline} ) * clamp ( \frac{{H}_{target} - {H}_{baseline}}{{H}_{alternate} - {H}_{baseline}} , 0 , 1 )$$

2. Calculation of the gain:

$$Gain = {2}^{( ( {Gain}_{max} + F ( x ) * {Gain}_{max} - {G}_{min} ) ) * {W}_{target} )}$$

3. Calculation of the output:

$$Output value [ component ] = Gain [ component ] * component$$

Where component is one of {Red, Green, Blue}.

NOTE 1. When k_{Component} equals zero, the input value becomes luma A and shall be the same for all components.

NOTE 2. It is recommended to perform the Adaptive Gain Curve calculations using double precision float and to create a lookup table with linear interpolation which can be adjusted by controlling the slew rate. Flat spots or saddles in the Adaptive Gain Curve could cause image quality issues.

NOTE 3. Annex 1 provides an example of calculating the Adaptive Gain Curve as a lookup table with 1024 grid points.

### Annex 2 Implementation of adaptiveGainCurveType (Informative)

### 2.1 General

This annex provides guidance on the implementation of adaptiveGainCurveType.

This information can be also used for creating lutAtoBType approximating Adaptive Gain Curve.

A recommended hierarchy of tags depending on the processing criteria is discussed at the end.

### 2.2 Calculating a Gain Lookup Table

The pseudocode below is an example of calculating a gain look-up table from the Adaptive Gain Curve.

```
#define MAXNODES 32
  typedef struct {
  float x;
  float y;
  float slope;
} node;
typedef struct {
    int
    nNodes;
    node nodes[MAXNODES];
} curve;
void computeCubicCoefficients( node *n1, node *n2, double &C3, double
&C2, double &C1, double &C0 )
{
    double x1 = n1−>x; double y1 = n1−>y; double s1 = n1−>slope;
    double x2 = n2−>x; double y2 = n2−>y; double s2 = n2−>slope;
    double u = (x1 − x2) * (x1 − x2);
    double n = s1 + s2 − 2.0 * (y2 − y1)/(x2 − x1);
    C3 = n / u;
    n = s2 − s1;
    u = 2.0 * (x2 − x1);
    e = 1.5 * (x1 + x2) * C3;
    C2 = (n / u) − e;
    C1 = s1 − 3.0 * x1 * x1 * C3 − 2.0 * x1 * C2;
    C0 = y1 − x1 * x1 * x1 * C3 − x1 * x1 * C2 − x1 * C1;
}
#define NTABLE 1024
void createLookupTable(curve *c, float table[NTABLE+1], float
gmapMin, float gmapMax)
{
  node *n = c−>nodes;
  node *end_n = c−>nodes + nNodes − 1;
  float xlo = n−>pt.x;
  float xhi = (n + 1) −>pt.x;
  double C3, C2, C1, C0;
  computeCubicCoefficients(n, n+1, C3, C2, C1, C0);
  // compute an NTABLE-element table describing the gain factor
  float slew_transfer = −1.0;
  float minimum_slew = 0.00025f;
  for (int i = 0; i <= NTABLE; i++, slew_tranfer += minimum_slew) {
    // evaluate x at this index
    float x = (float) i / (float)NTABLE;
    // advance into the valid node interval enclosing x. this requires
    two nodes
    while (x > xhi && (n + 1) < end_n) {
      n++;
      xlo = n−>x;
      xhi = (n + 1)−>x;
      computeCubicCoefficients(n, n+1, C3, C2, C1, C0);
    }
    // if not enough nodes, we sample-and-hold the curve value at the
    last interval's end x
    x = (x > xhi) ? xhi : x;
    // evaluate normalized linear gain using doubles (result may be
    float, though)
    double dx = (double)x;
    float nlg = C3 * dx*dx*dx + C2 * dx*dx + C1 * dx + C0;
    // convert normalized linear gain to gain factor
    table[i] = powf(2.0f, gmapMin + nlg * (gmapMax − gmapMin));
    // compute y: the factor multiplied by luma_A
    // so the transfer table would actually be f(x) = y * x
    float y = table[i];
    // compute transfer table value(x*y)
    float transfer = x + y;
    if (transfer < slew_transfer)
    {
      transfer = slew_transfer
      y = transfer / x;
    }
    table[i] = y;
    slew_transfer = transfer;
  }
}
```

### 2.3 Applying a Gain Lookup Table

The pseudocode below is an example of applying a gain look-up table.

```
typedef struct
{
  float r; float g; float b;
} RGB_float;
float gain_lookup(float* table, size_t count, float y)
{
  size_t max_index = count−1;
  float fmax = (float)max_index;
  float fIndex = clampf_to_range(fmax * y, 0.0f, fmax);
  uint32_t index = (uint32_t) fIndex;
  float fract = fIndex − index;
  float y1 = table [index];
  float y2 = table [MIN(index + 1, max_index)];
  float gain = (y1 + (y2 − y1) * fract);
  return gain;
}
RGB_float apply_gain_preview(float R, float G, float B)
{
  float y = R*rCoefficient +
    G*gCoefficient +
    B*bCoefficient +
    MAX(R, MAX(G, B))*maxCoefficient +
    MIN(R, MIN(G, B))*minCoefficient;
  float gain = gain_lookup(lookup_table, gain_lookup_table_count, y);
  RGB_float out = {0.0};
  G*gCoefficient +
  out.r = gain * R;
  out.g = gain * G;
  out.b = gain * B;
  return out;
}
```

2.4 Approximating Adaptive Gain Curve by luAToBType for HDR to SDR Tone Mapping

A lutAToBType tag can be created to approximate the application of Adaptive Gain Curve for tone mapping an HDR image to SDR. In this case it is recommended that the A curves of the lutAToBType are used to linearize the input data, and the 3D CLUT is calculated by applying the Adaptive Gain Curve to a uniformly distributed 3D grid of RGB components. The CLUT is followed by a matrix converting RGB primaries to CIEXYZ.

Representing the EOTF in a form of a lookup table sometimes leads to loss of precision due to an insufficient number of tone levels. In this case it is recommended to use an additional encoding step to preserve precision. For example, in the case of PQ EOTF, the additional encoding step could consist of taking the values of the PQ ETOF to the power of ⅕ (x\hat{ }⅕). This would then need to be undone (i.e. x\hat{ }5) before applying the preview curve to calculate 3D CLUT entries

It is possible to make additional adjustments to produce rendering intents A2B0, A2B1 and A2B2. The presence of lutAToBType tags in the profile to approximate the Adaptive Gain Curve for a specific rendering intent is indicated in the adaptiveGainCurveType header as described in Table 1 by specified target headroom which was used for calculations. It is recommended that the SDR target of 1.0 is used for the reason of backward compatibility with the systems which don't support the concept of headroom.

2.5 Approximating Adaptive Gain Curve by luAToBType for SDR to HDR Tone Mapping.

The Adaptive Gain Curve can be used for converting SDR to HDR, so potentially a lutAtoBType tag could be created for such a conversion, however no attempts were made by the authors of this proposal to confirm that.

### 2.6 HDR Tone Mapping Method Hierarchy

Adaptive Gain Map and multiple tags in ICC profile related to HDR tone mapping provide multiple choices of rendering method and the selection of a specific method could be based on different criteria like desired rendering quality, available processing power, available memory, rendered image size, etc.

The hierarchy based on expected quality is as follows:
1. Adaptive Gain Map, image specific spatial conversion.
2. Adaptive Gain Curve, image specific global conversion.
3. v4 AToB0 created from Adaptive Gain Curve.
4. CICP tag, ITU Recommended Tone Mapping, non-image specific global conversion.
5. Non-image specific v4 AToB0 tag based on generic global conversion.

We claim:

1. A method, comprising:
capturing image information by an image sensor, the capturing generating information of an image in a source representation,
responsive to capture of the image by the image sensor, generating a gain curve representing a transform of the image from the source representation to a destination representation, and
storing the source representation of the image and data of the gain curve in a file.

2. The method of claim 1, wherein the image is part of a video sequence represented by the file.

3. The method of claim 2, wherein the file contain a plurality of gain curves, each corresponding to a single frame of the video sequence.

4. The method of claim 2, wherein the file contain a plurality of gain curves, at least one gain curve corresponding to a plurality of frames of the video sequence.

5. The method of claim 1, further comprising transmitting the file, including the image frame and the gain curve, to a destination device.

6. The method of claim 1, wherein the generating generates the gain curve from a gain map having gain values corresponding to spatial locations of pixels of the image frame.

7. The method of claim 1, further comprising storing a plurality of gain curves in the file, each gain curve representing a transform of the image data from the source representation of the frame to a respective destination representation.

8. The method of claim 1, wherein the gain curve is represented as a cubic spline in which transitions between curve segments is represented by coordinates.

9. The method of claim 1, wherein the gain curve represented in a table that includes a count of piece-wise linear elements in the gain curve and, for each piece-wise linear element in the gain curve, a representation of a two-dimensional coordinate and a slope of the respective piece-wise linear element.

10. The method of claim 1, wherein the gain curve is represented by metadata that includes:
an identifier of baseline headroom,
an identifier of minimum Red channel gain,
an identifier of maximum Red channel gain,
an identifier of a Red channel weight coefficient,
an identifier of minimum Green channel gain,
an identifier of maximum Green channel gain,
an identifier of a Green channel weight coefficient,
an identifier of maximum Blue channel gain,
an identifier of minimum Blue channel gain,
an identifier of a Blue channel weight coefficient,
an identifier of a MAX(R,G,B) weight coefficient,
an identifier of a MIN(R,G,B) weight coefficient, and
an identifier of a Color component weight coefficient.

11. A method, comprising:
storing a frame of image data in a file,
generating a gain curve representing a transform of the image data from a source representation of the frame to a destination representation, and
storing data of the gain curve in the file with the stored frame.

12. The method of claim 11, wherein the stored image frame is output from a camera system that generates the gain curve.

13. The method of claim 11, wherein the stored image frame is output from an image coder that generates the gain curve.

14. The method of claim 11, wherein the stored image frame is output from an editor system that generates the gain curve.

15. The method of claim 11, further comprising transmitting the file, including the image frame and the gain curve, to a destination device.

16. The method of claim 11, wherein the generating generates the gain curve from a gain map having gain values corresponding to spatial locations of pixels of the image frame.

17. The method of claim 11, further comprising storing a plurality of gain curves in the file, each representing a transform of the image data from the source representation of the frame to a respective destination representation.

18. The method of claim 11, wherein the gain curve is represented as a cubic spline in which transitions between curve segments is represented by coordinates.

19. The method of claim 11, further comprising, prior to the generating, performing noise filtering on the image data, wherein the gain curve is generated from the denoised image data.

20. The method of claim 11, wherein the image is part of a video sequence represented by the file.

21. The method of claim 20, wherein the file contain a plurality of gain curves, each corresponding to a single frame of the video sequence.

22. The method of claim 20, wherein the file contain a plurality of gain curves, at least one gain curve corresponding to a plurality of frames of the video sequence.

23. The method of claim 11, further comprising, prior to the generating, partitioning the image data according to region of interest detection, wherein the generating is performed separately on each partition of image data to generate separate gain curves, which are stored in the file.

24. The method of claim 11, wherein the gain curve represented in a table that includes a count of piece-wise linear elements in the gain curve and, for each piece-wise linear element in the gain curve, a representation of a two-dimensional coordinate and a slope of the respective piece-wise linear element.

25. The method of claim 11, wherein the gain curve is represented by metadata that includes:
an identifier of baseline headroom,
an identifier of minimum Red channel gain,
an identifier of maximum Red channel gain,
an identifier of a Red channel weight coefficient,
an identifier of minimum Green channel gain,
an identifier of maximum Green channel gain,
an identifier of a Green channel weight coefficient,
an identifier of maximum Blue channel gain,
an identifier of minimum Blue channel gain,
an identifier of a Blue channel weight coefficient,
an identifier of a MAX(R,G,B) weight coefficient,
an identifier of a MIN(R,G,B) weight coefficient, and
an identifier of a Color component weight coefficient.

26. A method, comprising:
receiving, at a destination device, image data representing an image at a plurality of spatial locations of the image, and data of at least one gain curve representing a transform of the image data from a source representation of the frame to a destination representation, and
transforming the image data from the source representation based on the gain curve to generate an output image.

27. The method of claim 26, wherein the image data and the gain curve are received from a source device.

28. The method of claim 26, wherein the gain curve is represented as a cubic spline in which transitions between curve segments is represented by coordinates.

29. The method of claim 26, wherein
the receiving includes receiving at least a plurality of gain curves, each representing a transform of the image data from the source representation of the frame to a respective destination representation, and
the transforming transforms the image data from the source representation based on a selected one of the gain curves.

30. The method of claim 26, further comprising performing noise injection on the output image.

31. The method of claim 26, further comprising deriving a transform from the gain curve and a desired destination property of the output image, wherein the transforming transforms the image data from the source representation according to the derived transform.

32. The method of claim 26, further comprising image is part of a video sequence, and the receiving includes receiving at least a plurality of gain curves, each corresponding to a single frame of the video sequence.

33. The method of claim 26, wherein the image is part of a video sequence, and the receiving includes receiving at least a plurality of gain curves, at least one gain curve corresponding to a plurality of frames of the video sequence.

34. The method of claim 26, wherein the gain curve calculated from a table that includes a count of piece-wise linear elements in the gain curve and, for each piece-wise linear element in the gain curve, a representation of a two-dimensional coordinate and a slope of the respective piece-wise linear element.

35. The method of claim 26, wherein the gain curve is calculated from metadata that includes:
an identifier of baseline headroom,
an identifier of minimum Red channel gain,
an identifier of maximum Red channel gain,
an identifier of a Red channel weight coefficient,
an identifier of minimum Green channel gain,
an identifier of maximum Green channel gain,
an identifier of a Green channel weight coefficient,
an identifier of maximum Blue channel gain,
an identifier of minimum Blue channel gain,
an identifier of a Blue channel weight coefficient,
an identifier of a MAX(R,G,B) weight coefficient,
an identifier of a MIN(R,G,B) weight coefficient, and
an identifier of a Color component weight coefficient.

36. A method, comprising:
retrieving video frames from a file, the video frames represented in a source representation,
retrieving gain curves for the video frames from the file,
transforming the video frames from the source representation to a destination representation based on the gain curves.

37. The method of claim 26, wherein the gain curve is represented as a cubic spline in which transitions between curve segments is represented by coordinates.
